(19) United States
(12) Patent Application Publication
(10) Pub. No.: US 2004/0155833 A1
(43) Pub. Date: Aug. 12, 2004

(54) Display control device, computer, image display device, and image display system

(75) Inventors: Tsutomu Ishii, Ebina-shi (JP); Tsunemasa Mita, Ebina-shi (JP); Takeshi Matsunaga, Ashigarakami-gun (JP); Hiroshi Arisawa, Ebina-shi (JP); Ikutaroh Nagatsuka, Ebina-shi (JP); Takeo Kakinuma, Ebina-shi (JP); Yasunari Nishikata, Ebina-shi (JP); Haruo Harada, Ebina-shi (JP); Kiyoshi Shigehiro, Ashigarakami-gun (JP); Yasufumi Suwabe, Ashigarakami-gun (JP); Yoshinori Machida, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 10/663,820

(22) Filed: Sep. 17, 2003

(30) Foreign Application Priority Data
Feb. 7, 2003 (JP) 2003-30307
Feb. 12, 2003 (JP) 2003-33727

(51) Int. Cl. G09G 5/00

(52) U.S. Cl. 345/1.1

(57) ABSTRACT

The present invention provides a display control device which easily recognize the number of connected display media and which always display an optimum image on the respective display media even if an arbitrary display medium is attached or detached.

A writing device constituting an electronic book includes a connector to which electronic papers are detachably connected. The number of connected sheets of electronic paper is recognized, and is output to a host computer. In the host computer, display data is output on the basis of the number of electronic papers, and the display data is written in the electronic papers by a write control unit. When a change of connections of the electronic papers is detected by the detection unit, a part of images displayed on the electronic papers is rewritten depending on the detected connection state.

### CROSS-REFERENCE TO RELATED APPLICATION

This application claims priority under 35 U.S.C. 119 from Japanese Patent Applications Nos. 2003-30307 and 2003-33727, the disclosure of which are incorporated by reference herein.

### BACKGROUND OF THE INVENTION

1. Field of the Invention

The present invention relates to a display control device, a computer, an image display device, and an image display system and, more particularly, to a display control device, a computer, an image display device, and an image display system which are preferably used in a so-called electronic book which transmits information to a display medium for displaying written image information.

2. Description of the Invention

A display device which is easily portable and which can easily display graphics and charactersis proposed (for example, see Japanese Patent Application Laid-Open (JP-A) No. 5-35223, pp.2-3, FIG. 1). In recent years, with development of information-oriented society, the performance of a display medium such as a LCD (Liquid crystal display) is dramatically improved. However, this display medium is poorer than “paper”, which has been used as an information medium from ancient days, in readability and usability. Therefore, nowadays, a new concept, i.e., so-called “electronic paper” is proposed as a display medium which can be handled as if it were a paper medium having good portability. The electronic paper is rewritable and erasable, and can maintain information if necessary. However, since a display on the electronic paper is planarly achieved in a limited region, when pieces of information are referred to, the display must be rewritten for each information.

For this reason, a display device obtained such that a predetermined number of planar display media are bundled to be integrated is proposed (for example, see JP-A No. 6-274458, pp.3-4, FIG. 1 and JP-A No. 2000-292777, pp.2-3, FIG. 1). In such a display device, information to be displayed can be rewritten if necessary. However, since an amount of information which can be displayed is constant, excessive number of display devices must be carried when an amount of information is small. In addition, when an amount of information is large, a plurality of display devices must be used to separately write the information in the respective display devices.

In order to solve the above problem, an electronic paper file with a plurality of detachable display media having memory properties is proposed (for example, see JP-A No. 2001-312227, pp.3-4, FIG. 1). The electronic paper file described in JP-A No. 2001-312227 is obtained by bundling sheets of electronic paper like a book. When display media are designed to be detachable from the main body, as in a loose-leaf book made from paper, only a desired page (desired display medium) can be picked up and carried.

However, in the electronic paper file from which display media can be detached, the number of loaded display media (sheets of electronic paper) cannot be recognized. More specifically, in a conventional technique, although the detaching state of a single display medium can be detected, the electronic paper file cannot be recognized as a whole.

Furthermore, general books such as books of literary works and magazines have different numbers of pages, respectively. For this reason, when the contents of a general book are displayed on an electronic file, the number of pages of the book is often different from the number of sheets of paper. In this case, other display media must be inserted into the electronic file. However, when new display media are inserted into the electronic file, the pages of the electronic file are disadvantageously replaced with each other.

In addition, in the electronic file, when a desired display medium is picked from the main body, a page corresponding to the picked display medium disadvantageously falls off. Even though a reader reads the electronic file until the final page (final display medium), if the book has other pages to be read, the contents of the electronic file cannot be rewritten by a simple operation.

### SUMMARY OF THE INVENTION

The present invention has been made in consideration of the above circumstances, and has as its object to provide a display control device and a computer which can easily recognize the number of connected display media and a display control device, an image display device, and an image display system which can always display optimum images on respective display media even if an arbitrary display medium is inserted or removed.

To this end, a first aspect of the invention is to provide a display control device comprising: a connection unit for connecting a plurality of display media in which image information to be displayed can be written by an external input; a recognition unit for recognizing the number of display media connected to the connection unit; and a writing unit for writing related information for writing the image information in the display media.

The display control device according to the invention is connected to a plurality of display media by a connection unit. Image information to be displayed can be written in the display medium by an external input. The writing unit writes related information for writing the image information is written in the display media. As the related information, image information itself or control information of a display medium for writing the image information in the display medium. For example, image information can be electromagnetically written in a display medium. When information is to be electrically written, an electric signal of image information to a display medium and control information of the display medium is directly transmitted to the display medium, and the image information to the display medium can be written. When information is to be optically written, an electric signal of control information or the like of a display medium is transmitted to set a state in which optical writing can be performed, and image information composed of optical information is written in the display medium to make it possible to write the image information into the display medium. The recognition unit recognizes the number of display media connected to the connection unit. For this reason, the display control device can easily recognize the number of display media connected to the connection unit and the number of displays which can be display media. Therefore, with reference to a recognition result of the recognition unit, the display media connected in the display control device can be recognized.

In the display control device, the display medium can be detachably connected to the connection unit.

One display medium or a plurality of display media can be connected to the display control device, and the display media are detachably designed, so that the number of display media to be connected changes. The changed number of connected display media is recognized by the recognition unit, so that the number of connected display media can be reliably recognized.

The display control device can further comprise a detection unit for detecting that the display medium is connected to the connection unit.

The one display medium or the plurality of display media connected to the display control device are set in a writable state when the display media are connected to the display control device. Therefore, the display control device further comprises a detection unit for detecting that the display medium is connected to the display control device to make it possible to reliably recognize connection of the display medium to the display control device.

In the display control device, the recognition unit recognizes the number of display media by counting the number of display media detected by the detection unit.

When the number of display media is recognized by the recognition unit, connected display media are counted. In this manner, when the display media are paper-like display media, the number of display media can be recognized, and the number of display media which can be displayed as an electronic book when a plurality of paper-like display media are bundled to constitute an electronic book can be recognized. When a paper-like display medium is used, the front and rear sides of the display medium may be recognized as different display media or as one display medium.

In the display control device, the connection unit is connected to each display medium by being brought into contact with the display medium.

When the display control device is connected to a plurality of display media by the connection unit, the display control device may be connected to the plurality of display media such that related information can be written by the writing unit. The display control device is connected to the display media by being brought into contact with the display media to make it possible to reliably connect the display control device to the display media.

In the display control device, the display media have connector elements, and the connection unit has a plurality of connection sections to be connected to the connector elements of the display media.

When the display control device is to be connected to the display media by the connection unit, both of the display media and the display control device preferably have connection portions, respectively. Therefore, the display media have connector elements, and various pieces of information are given and received through the connector elements. On the other hand, in the display control device side, the connection unit has a plurality of connection sections to be connected to the connector elements of the display media. In this manner, the various pieces of information can be reliably given and received between the connector elements and the connection sections.

In this case, when the number of display media is recognized by the recognition unit, the number of display media can be rapidly recognized by detecting in advance whether the display media are connected or not. Therefore, the connection unit comprises a state detection unit representing a connection state or a disconnection state of the display medium for each of the connectable display media. The recognition unit counts the connection states in the state detection units of the connection unit. In this manner, the number of display media can be recognized by checking only the detection results of the state detection units, and the number of display media can be rapidly and easily recognized.

In the display control device, the display medium has a connection element to which an input terminal and an output terminal are connected, the connection unit comprises a terminal pair for each connectable medium, the terminal pari comprising a recognition signal supply terminal for outputting a recognition signal to the input terminal of the connection element and a recognition signal detection terminal for detecting a recognition signal from an output terminal of the connection element, and the recognition unit counts recognition signals at the recognition signal detection terminals of the connection unit.

When the number of display media is to be recognized by the recognition unit, the recognition is preferably performed with a simple and convenient configuration. Therefore, the display medium side has the connection element to which the input terminal and the output terminal are connected. The connection unit side of the display control device comprises a terminal pair for each connectable display medium, the terminal pair comprising a recognition signal supply terminal for outputting a recognition signal to the input terminal of the connection element and a recognition signal detection terminal for detecting a recognition signal from the output terminal of the connection element. Therefore, when a display medium is connected, a recognition signal output from the recognition signal supply terminal is input to the recognition signal detection terminal through the input terminal and the output terminal arranged on the display medium side. In this manner, the recognition unit counts recognition signals at the recognition signal detection terminals of the connection unit to make it possible to recognize the number of display media with an easy and simple configuration.

In the display control device, the connection unit is connected to display media by radio communication without being in contact with the display media.

When a plurality of display media are to be connected by the connection unit, the display media may be connected such that related information can be written by the writing unit. The invention is not limited to the configuration in which the display control device is in contact with the display media. For this reason, the connection unit can also be connected to the display media by radio communication without being in contact with the display media. With this connection configuration, loose connection caused by defective contact can be suppressed, and the connection unit can be reliably connected to the display media.

In the display control device, the display media have RFIDs representing pieces of unique information which can be given and received by radio communication, and the recognition unit counts the RFIDs.

The display media may have RFIDs representing pieces of unique information to discriminate the display media from each other. When the display control device is to be connected to the display media without being in contact with the display media, the display media have RFIDs which can be given and received by radio communication and which represents pieces of unique information, and the recognition unit counts the RFIDs. In this manner, the display media can be easily specified, and the number of display media can be conveniently recognized.

In the display control device, the display media are memory-type display media.

In order to improve the display media in portability, it is preferable that image information written for display is temporarily held (stored). Memory-type display media for maintaining the display of the image information written regardless of an external input are more preferably used. The memory-type display media maintains the image display in a normal state such as a non-electric state or an irradiation state by ambient light in which related information related to writing is not written. In this manner, the memory-type display medium can hold image information written for display. Even if the display medium is removed from the display control device, the contents to be displayed, i.e., image information can be held, and the image information to be displayed can be maintained.

The display control device further comprises a transmission unit for transmitting number information representing the number of display media recognized by the recognition unit.

In the display control device, related information for writing image information is written by the writing unit. The image information can be obtained by an external device. At this time, when the number of pieces of image information to be given to the display control device or the like is recognized by the external device, an appropriate number of pieces of image information may be provided. More specifically, the number of display media recognized by the display control device may be required to be used in the external device. Therefore, the display control device further comprises the transmission unit for transmitting number information representing the number of display media recognized by the recognition unit outside the display control device, so that usable display media can be easily recognized by an external computer or the like by only receiving the number information transmitted from the transmission unit.

In the display control device, the transmission unit transmits the number information to an external computer through a communication line.

The number of display media recognized by the display control device may be requested when a computer which handles the image information is used as an external device. When the external computer recognizes the number of pieces of image information by the external device, an appropriate number of pieces of image information can be received by the display control device side.

The display control device further comprises a receiving unit for receiving image information related to an image to be displayed on the display medium from an external computer, on the basis of the image information received by the receiving unit and the number of display media recognized by the recognition unit, the writing unit writes related information in the display media.

When information is to be written in the display media by the external computer which handles image information, the display control device may comprise a receiving unit. On the basis of the image information received by the receiving unit and the number of display media recognized by the recognition unit, the writing unit writes related information in the display media. In this manner, with respect to the image information from the external computer, the related information depending on an appropriate number of pieces of image information can be written.

In the display control device, the writing unit writes image information to be displayed on the display media as the related information.

When the image information is written in the display medium, it is preferable that the image information is electrically directly written by only connection. Therefore, the writing unit writes image information to be displayed in a display medium as related information, so that the image information to be displayed can be easily written in the display medium.

A second aspect of the invention is to provide a computer comprising: a storage unit for storing related information related to an image to be displayed on a display medium; a receiving unit for receiving the number of the display media; and a transmission unit for transmitting the image information on the basis of the number of the display media received by the receiving unit and the image information stored in the storage unit.

A connection state detected by the detection unit may include the number of display media connected to the connection unit or may be a displayable region of a display medium, insertion or removal of a display medium, replacement, or the like.

A third aspect of the invention is to provide a display control device comprising: a connection unit for detachably connecting to each of a plurality of display media; a detection unit for detecting connection states between the display media and the connection unit; and a rewrite control unit for, when a change of a connection state between at least one of the display media and the connection unit is detected by the detection unit, controlling rewriting of at least a part of an image displayed on the display medium connected to the connection unit depending on the detected connection state.

A fourth aspect of the invention is to provide an image display device comprising: a plurality of display media; and a display control device including a connection unit for detachably connecting each of the plurality of display media, a detection unit for detecting connection states between the display media and the connection unit, and a rewrite control unit for, when a change of a connection state between at least one of the display media and the connection unit is detected by the detection unit, controlling rewriting of at least a part of an image displayed on the display medium connected to the connection unit depending on the detected connection state.

A fifth aspect of the invention is to provide an image display system comprising: an image display device including a plurality of display media, a connection unit for detachably connecting each of the plurality of display media, a detection unit for detecting connection states between the display media and the connection unit, and a rewrite control unit for, when a change of a connection state between at least one of the display media and the connection unit is detected by the detection unit, controlling rewriting of at least a part of an image displayed on the display medium connected to the connection unit depending on the detected connection state; and a main control device for carrying out transmission of images and instruction for writing of the images with respect to a display control device of the image display device.

The connection unit may comprise one connection unit or a plurality of connection units if the plurality of display media can be detachably connected to the connection unit. One connection unit to which only one display medium is connected may be used, or one connection unit to which a plurality of display media are simultaneously connected may be used.

The detection unit detects connection states between the display media and the connection unit. The connection states correspond to states representing whether the display media are connected to the connection unit at respective connection states or not. A method of detecting the connection state is not limited to a specific method. For example, a mechanical or electrical connection state is monitored, or a connection state may be optically monitored by using an optical sensor. The connection position may be detected by using a position detection unit for detecting a position where a display medium is connected to the connection unit.

When the connection state is changed, the rewrite control unit controls rewriting of the whole or a part of an image for a display medium currently connected to the connection unit. In this case, the change of the connection state corresponds to, e.g., a case in which a display medium is removed from the connection unit or a case in which a display medium is inserted into the connection unit. The rewrite control unit rewrites at least a part of an image displayed on a display medium connected to the connection unit depending on a detected connection state.

Therefore, in the display control device, the image display device, and the image display system according to the invention, when a change of a connection state between at least one of the display media and the connection unit is detected, rewriting of at least a part of an image displayed on the display medium connected to the connection unit is controlled depending on the detected connection state to make it possible to display an optimum image on the loaded display medium even if an arbitrary display medium is detached.

### BRIEF DESCRIPTION OF THE DRAWINGS

FIG. 1 is a block diagram showing a conceptual configuration of an electronic book system according to the first embodiment of the present invention.

FIG. 2 is a block diagram showing schematic functional configurations of the electronic book system according to the first embodiment of the invention.

FIG. 3 is a conceptual diagram showing a schematic configuration of a connection relationship between a writing device and a sheet of electronic paper in the electronic book system according to the first embodiment of the invention.

FIG. 4 is a flow chart showing a flow of processes executed in a recognition unit included in the writing device according to the first embodiment of the invention.

FIG. 5 is a flow chart showing a flow of processes executed in a host computer according to the first embodiment of the invention.

FIG. 6 includes conceptual diagrams showing schematic configurations of a writing device and electronic paper in the electronic book system according to the second embodiment of the invention, in which FIG. 6A shows the relationship between the writing device and two sheets of electronic paper, FIG. 6B shows the relationship between the writing device and four sheets of electronic paper, and FIG. 6C shows the relationship between the writing device and eight sheets of electronic paper.

FIG. 7 is a block diagram showing schematic functional configurations of an electronic book system according to the third embodiment of the invention.

FIG. 8 is a block diagram showing schematic functional configurations of an electronic book system according to the fourth embodiment of the invention.

FIG. 9 is a flow chart showing a flow of processes executed in a recognition unit included in a writing device according to the fourth embodiment of the invention.

FIG. 10 is a block diagram showing a functional configuration of an electronic book system.

FIG. 11 is a flow chart showing an operation procedure of a control unit of the writing device from which a sheet of electronic paper is picked.

FIGS. 12A, 12B, and 12C are diagrams showing manners of picking sheets of electronic paper from the electronic book system.

FIG. 13 is a flow chart showing an operation procedure of the control unit of the writing device when a new sheet of electronic paper is inserted.

FIGS. 14A, 14B, and 14C are diagrams showing manners of inserting sheets of paper into the electronic book.

FIG. 15 is a flow chart showing an operation procedure of the control unit of the writing device when a sheet of electronic paper at an arbitrary position is replaced.

FIGS. 16A, 16B, and 16C are diagrams showing manners of picking sheets of electronic paper from the electronic book.

FIG. 17 is a diagram showing one image on which a rhombus is displayed.

FIG. 18 is a flow chart showing an operation procedure of a control unit when a magnification of a display image is changed simultaneously with addition of a sheet of electronic paper.

FIG. 19A is a diagram showing a reference image displayed on two sheets of electronic paper. FIG. 19B is a diagram showing a reference image displayed on three sheets of electronic paper.

FIG. 20 is a flow chart showing an operation procedure of a control unit 74 when a display range of a display image is changed simultaneously with addition of a sheet of electronic paper.

FIG. 21A is a diagram showing a reference image displayed on two sheets of electronic paper 12, and FIG. 21B is a diagram showing a reference image displayed on three sheets of electronic paper.

### DETAILED DESCRIPTION OF THE INVENTION

Embodiments of the present invention will be described below in detail with reference to the accompanying drawings.

[First Embodiment]

In the first embodiment, the invention is applied to an electronic book system which gives and receives data to/from an electronic book obtained by bundling sheets of electronic paper (memory-type display medium) having memory properties.

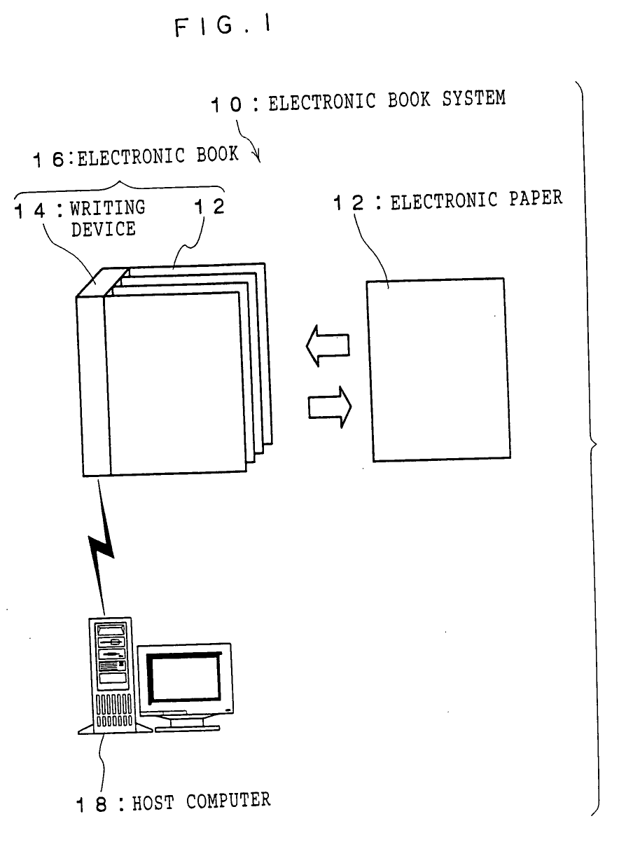

As shown in FIG. 1, an electronic book system 10 according to the embodiment of the invention is constituted by sheets of electronic paper 12, a writing device 14 which can bundle the sheets of electronic paper 12 when the sheets of electronic paper 12 are detachably loaded, and a host computer 18 for outputting image information to be written in the sheets of electronic paper 12 through the writing device 14. A group of electronic papers obtained by loading one or more sheets of electronic paper 12 on the writing device 14 is defined as an electronic book 16.

The sheets of electronic paper 12 is designed such that the image information to be displayed can be rewritten. With respect to writing of the image information, display media are roughly divided into an optically writable display medium and an electrical writable display medium. The display media include display media having memory functions of maintaining written image information, and display media which do not have memory functions and which display images only when signals are input.

As examples of the display media having memory functions, a display medium achieved by microcapsule electrophoresis, a display medium achieved by inplane electrophoresis, a display medium achieved by Twisting Ball (Gyricon) technique, a display medium achieved by toner display technique, a display medium achieved by guest-host liquid crystal technique, a display medium achieved by ferroelectric liquid crystal technique, a display medium achieved by cholesteric liquid crystal technique, a display medium achieved by leuco dye rewritable media technique, a display medium achieved by polymer/dispersed long chain low molecule rewritable media technique, and the like are known.

On the other hand, as examples of display media which do not have memory functions and which display information only when signals are input, a CRT, an organic EL, a liquid crystal display device, a projection device, and the like are known.

In this embodiment, the sheet of electronic paper 12 has good portability, and is designed such that image information can be held and referred to even after the image information is written. For this reason, the sheet of electronic paper 12 functioning as a display medium having a memory function is employed.

In the following description, a case in which the sheet of electronic paper 12 having a memory function is employed as an example of the display media is explained. However, the invention is not limited to this example. A display medium which displays information only when a signal is input may be employed.

In the embodiment, a configuration in which sheets of electronic paper 12 can be connected to the writing device 14 is explained as the electronic book 16. However, the writing device 14 and the electronic paper 12 maybe able to be, at least, attached and detached from/to each other, and a state in which the sheet of electronic paper 12 is connected to the writing device 14 is not limited to a specific state. More specifically, the sheet of electronic paper 12 is designed such that the sheet of electronic paper 12 can be pivoted about the writing device 14 while the sheet of electronic paper 12 is connected to the writing device 14, so that a so-called page spread state can be established.

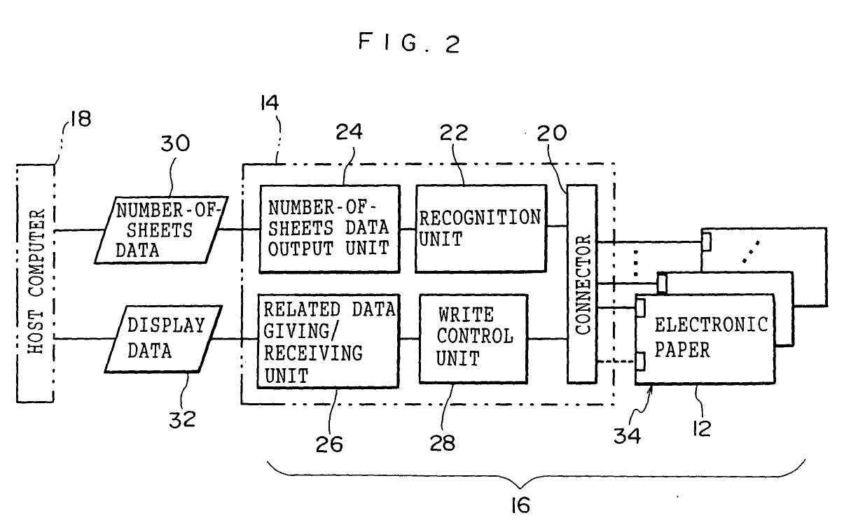

FIG. 2 shows the conceptual configuration of the electronic book system 10. The writing device 14 comprises a connector 20 to/from which the sheets of electronic paper 12 can be attached and detached. A number-of-sheets data output unit 24 is connected to the connector 20 through a recognition unit 22, and the output side of the number-of-sheets data output unit 24 is connected to the input side of a host computer 18. The output side of the host computer 18 is connected to a write control unit 28 through a related data receiving/giving unit 26, and the output side of the write control unit 28 is connected to the connector 20.

The connector 20 included in the writing device 14 is designed such that the sheet of electronic paper 12 can be attached to and detached from the connector 20 and such that the sheet of electronic paper 12 is electrically connected to the connector 20 in a loading state. The writing device 14 and the sheet of electronic paper 12 are connected to each other such that a connector terminal unit 34 formed on the sheet of electronic paper 12 is brought into contact with the connector 20 included in the writing device 14 (to be described later).

The recognition unit 22 includes a computer configuration, and is a function unit for recognizing one or more sheets of electronic paper 12 connected to the connector 20. This recognition is achieved by calculating the number of connected sheets of electronic paper 12 (in this embodiment, since the electronic paper 12 is planar, the number of sheets is used) The number-of-sheets data output unit 24 is a function unit for outputting the number of sheets of electronic paper 12 recognized by the recognition unit 22 as number-of-sheets data 30.

The related data receiving/giving unit 26 includes a computer configuration, and is a function unit for giving/receiving various pieces of related data from the host computer 18. The related data receiving/giving unit 26 mainly gives and receives display data 32 which is image information and information related thereto used when image information is written by the sheet of electronic paper 12. The write control unit 28 is a function unit, including a computer configuration, for performing control for writing image information in the sheet of electronic paper 12.

The case in which the function units of the writing device 14 include computer configurations has been described. However, the computer configurations may be formed as another main control unit, and the function units may be controlled by the main control unit.

Since the host computer 18 is a known electric configuration, a description of the host computer 18 will be omitted. The host computer 18 may be a computer selected from a so-called standalone computer, a server computer, and a computer for distributing images and the like.

The configuration constituted by the connector 20 and the recognition unit 22 in the writing device 14 corresponds to a minimum configuration of the display control device according to the invention. The sheet of electronic paper 12 corresponds to a display medium according to the invention. The connector 20 corresponds to the connection unit according to the invention and an information transmission portion in a write operation of the writing unit, and the recognition unit 22 corresponds to a recognition unit according to the invention.

The write control unit 28 included in the writing device 14 corresponds to the writing unit according to the invention, and the number-of-sheets data output unit 24 corresponds to a transmission unit according to the invention.

The host computer 18 corresponds to the external computer according to the invention. The function portion for receiving the number-of-sheets data 30 of the host computer 18 corresponds to a receiving unit in the computer according to the invention. The function portion for outputting the display data 32 corresponds to the transmission unit in the computer according to the invention. The memory, built in the host computer 18, for storing the display data 32 corresponds to the storage unit in the computer according to the invention.

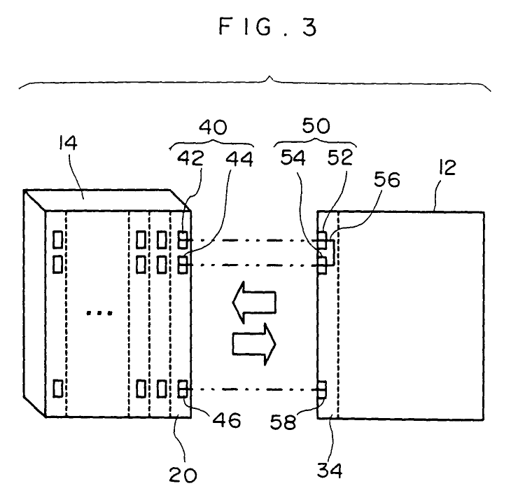

FIG. 3 shows a connector peripheral relationship between the writing device 14 and the sheet of electronic paper 12 connected to each other. In the writing device 14, the plurality of connectors 20 to/from which the sheets of electronic paper 12 can be attached and detached are arranged in parallel to constitute the electronic book 16. Each of the connectors 20 comprises a recognition terminal unit 40 and a signal terminal 46. The recognition terminal unit 40 is constituted by a supply terminal 42 for supplying a recognition signal and a detection terminal 44 for detecting a return signal (recognition signal) from the sheet of electronic paper 12.

The recognition signal supplied from the supply terminal 42 is output from the recognition unit 22. The detection signal of the detection terminal 44 is output to the recognition unit 22. The display data 32 from the write control unit 28 is supplied to the signal terminal 46 for the sheet of electronic paper 12.

The sheet of electronic paper 12 comprises a recognition connection terminal unit 50 at a position corresponding to a recognition terminal unit 40. The recognition connection terminal unit 50 is constituted by a receiving terminal 52 for receiving a recognition signal and an output terminal 54 for outputting a return signal (recognition signal). The receiving terminal 52 and the output terminal 54 are short circuited by a connection line 56. Therefore, when the writing device 14 and the sheet of electronic paper 12 are loaded, a recognition signal supplied from the writing device 14 is directly returned. The sheet of electronic paper 12 comprises a connection signal terminal 58 at a position corresponding to the signal terminal 46.

In this embodiment, a voltage signal having a predetermined voltage (e.g., +5 V) is employed as a recognition signal. Therefore, when the sheet of electronic paper 12 is connected to the writing device 14, the voltage of +5 V can be detected by the detection terminal 44. When the sheet of electronic paper 12 is not connected to the writing device 14, the detection terminal 44 becomes free, and the voltage of +5 V is not detected. In this manner, it can be detected whether connection of the sheet of electronic paper 12 to the writing device 14 is permitted or not.

The writing device 14 comprises the parallel connectors 20 so that it can be detected that the sheets of electronic paper 12 are attached or detached. However, when recognition signals are time-serially supplied to the writing device 14, a position where the sheet of electronic paper 12 is connected can also be detected by the detection timing of the recognition signals.

The recognition terminal unit 40 constituting the connector 20 corresponds to an example of the connection unit according to the invention, and the signal terminal 46 corresponds to an example of the information transmission unit in writing of the writing unit according to the invention. The recognition connection terminal unit 50 corresponds to the connector element according to the invention, and the recognition terminal unit 40 and the connector 20 correspond to a connection portion of the connection unit according to the invention.

The detection terminal 44 constituting the recognition terminal unit 40 corresponds to an example of the detection unit according to the invention. The connection line 56 of the sheet of electronic paper 12 corresponds to an example of a connection element in the display medium according to the invention. The supply terminal 42 corresponds to the recognition signal supply terminal according to the invention. The detection terminal 44 corresponds to the recognition signal detection terminal.

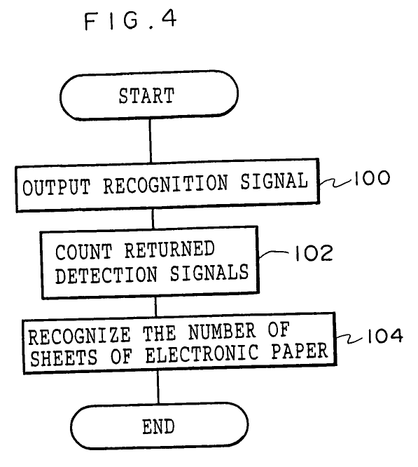

The operation of this embodiment will be described below. In the recognition unit 22, the process routine shown in FIG. 4 is executed. In step 100, a recognition signal (+5 V) is output to be supplied to the sheet of electronic paper 12 through the supply terminal 42. At this time, when the sheet of electronic paper 12 is loaded on the writing device 14 to connect the recognition terminal unit 40 and the recognition connection terminal unit 50 to each other, the detection signal (+5 V) is detected at the detection terminal 44. When the recognition terminal unit 40 and the recognition connection terminal unit 50 are not connected, the detection terminal 44 is free so that the detection signal (+5 V) cannot be detected. Therefore, in the next step 102, the number of detection signals is calculated. In the next step 104, the number of sheets of electronic paper 12 connected to the writing device 14 is recognized on the basis of the calculated value in step 102.

The recognition result, e.g., the number of connected sheets of electronic paper 12 in step 104 is output to the host computer 18 as the number-of-sheets data 30 by the number-of-sheets data output unit 24.

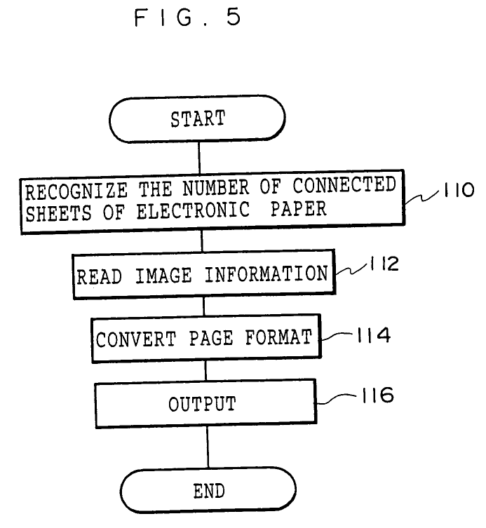

The processes performed in the host computer 18 will be described below. In the host computer 18, the process routine in FIG. 5 is executed to recognize the number of connected sheets of electronic paper 12 connected to the writing device 14 in step 110. This process is performed by reading the number-of-sheets data 30 output from the number-of-sheets data output unit 24.

In the next step 112, image information and to be output to the electronic book 16, such as pre-stored image information and image information which is stored in another device, are read. In the next step 114, a page format conversion process is performed on the basis of the number of connected sheets of electronic paper 12 and the image information. In the next step 116, the number of connected sheets of electronic paper and the image information are output to the writing device 14.

The page format conversion process is a process of transforming image information read in step 112 into image information depending on the number of connected sheets of electronic paper 12 constituting the electronic book 16.

More particularly, when book data of an electronic book or the like is read to be displayed on the electronic book 16, the number of pages which can be displayed on the electronic book 16 is a part of the number of all pages of the electronic book. Therefore, page format conversion for generating image information of the number of displayable pages, i.e., the number of pages recognized by the writing device 14 on the basis of the book data is performed. When the converted data is output as the display data 32, the image information corresponding to the number of connected pages can be displayed on the electronic book 16.

In the writing device 14 of the electronic book 16, the display data 32 is received by the related data receiving/giving unit 26, and the related data receiving/giving unit 26 outputs the display data 32 to the write control unit 28. The write control unit 28 outputs image information to be written in the sheet of electronic paper 12 to the sheet of electronic paper 12 through the connector 20 (and the connector terminal unit 34). In this manner, the pieces of image information are displayed on the sheet of electronic paper 12 loaded on (connected to) the electronic book 16.

As described above, in this embodiment, since the number of sheets of electronic paper 12, which is connected to the writing device 14 and constitutes the electronic book 16, can be recognized, image information depending on the number of sheets can be formed or given and received.

More specifically, when the number-of-sheets data 30 is transmitted to the host computer 18, the host computer 18 can transmit the image information with an amount of information depending on the number of sheets of electronic paper 12 connected to the writing device 14. For example, it is assumed that image information to be displayed includes a plurality of pages and that the sheets of electronic paper 12, the number of which is smaller than the number of pages of the image information are connected to the writing device 14. In this case, the image information corresponding to the number of sheets of the number-of-sheets data 30 is output, and the remaining pages can be sequentially transmitted, or remaining information can be transmitted.

For example, when the sheets of electronic paper 12, the number of which is larger than the number of pages of the image information to be displayed by one page or a plurality of pages are connected, the image information can be processed to control writing of only the image information corresponding to the number of sheets of the number-of-sheets data 30 in the writing device 14. In this manner, transmission of useless image information and useless write control can be suppressed. In addition, the number of unnecessary sheets of electronic paper 12 can be transmitted to a user.

The configuration of image information to be displayed can also be changed depending on the detected number-of-sheets data 30. For example, a main image can be extracted and output to be displayed.

In this embodiment, the number of connected sheets of electronic paper 12 is recognized by detecting recognition signals returned by the sheets of electronic paper 12. However, the invention is not limited to the configuration in which the connector terminal unit 34 (recognition connection terminal unit 50) used to recognize the number of sheets is arranged on the electronic paper 12 side. More specifically, a switch which is mechanically turned on when the electronic paper 12 is loaded may be arranged on the writing device 14 side to detect the ON signal, and the connected electronic paper 12 maybe recognized.

In this embodiment, the recognition connection terminal unit 50 and the connection signal terminal 58 are independently arranged. However, the recognition connection terminal unit 50 and the connection signal terminal 58 may be configured with the same connector with a group of terminals.

In the above embodiment, only the number of sheets of electronic paper 12 connected to the writing device 14 is recognized. However, in addition to the number of sheets, other information held by the sheets of electronic paper 12 may be recognized. The recognized other information may be output.

The other information includes image information such as the screen size, the screen resolution, the type of color (monochrome, 8-bit color, or full color) or the like of the electronic paper 12. As the unique values of the electronic paper 12, characteristic information such as the tolerance of a supply power (voltage), the refresh rate, and the like can also be used.

In this case, the other information is preferably recognized with reference to the data stored in the electronic paper 12 in advance. For this purpose, memories (ROM, RAM, or the like), in which the characteristics of the sheets of electronic paper 12 are stored, are preferably added to the sheets of electronic paper 12, respectively. In this case, when a general ROM or RAM is used, various pieces of information can be detected by using connection terminals. When an RFID (will be described later) is used, the information can be transmitted and received by air.

[Second Embodiment]

In the first embodiment, the electronic book 16 is constituted by the writing device 14 to which one sheet of electronic paper 12 or stacked sheets of electronic paper 12 are connected. However, in the second embodiment, the invention is applied to a structure in which the sheets of electronic paper 12 are arranged side by side (hereinafter, the structure is referred to as “page spread state” or “page spread”).

Since this embodiment has the same configuration as that of the first embodiment, the same reference numerals as in the first embodiment denote the same parts in the second embodiment, and a description thereof will be omitted.

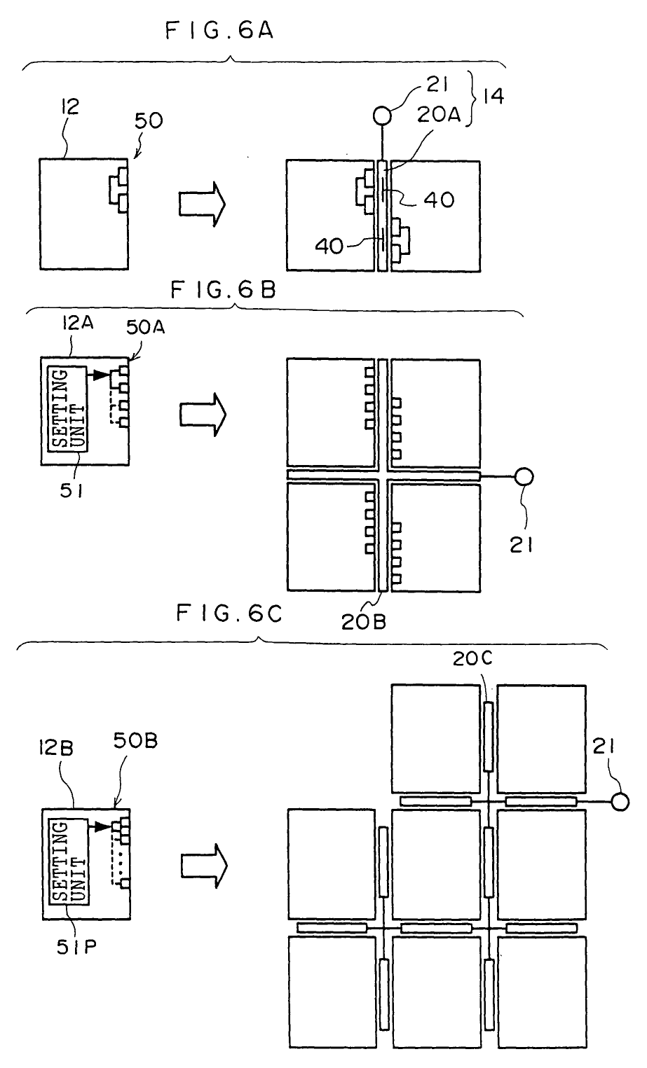

As shown in FIG. 6, an electronic book 16 according to this embodiment has a writing device for planarly connecting sheets of electronic paper 12. FIG. 6A shows an example of the electronic book 16 constituted by two sheets of electronic paper 12 in a page spread state. FIG. 6B shows an example of the electronic book 16 constituted by four sheets of electronic paper 12 in a page spread state. FIG. 6C shows an example of the electronic book 16 constituted by eight sheets of electronic paper 12 in a page spread state.

In the example shown in FIG. 6A, the sheets of electronic paper 12 each having the same recognition connection terminal unit 50 as in the first embodiment. The writing device 14 of the example comprises a connector 20A having counter contact surfaces and a processing unit 21, to make it possible to display two sheets of electronic paper 12 in a page spread state. The processing unit 21 is a processing unit constituted by a recognition unit 22, a number-of-sheets data output unit 24, a related data receiving/giving unit 26, and a write control unit 28.

The connector 20A comprises two connectors 20. Recognition terminal units 40 (connectors 20) are arranged at different positions to connect two sheets of electronic paper 12. More specifically, the recognition terminal units 40 are arranged at symmetric positions. For this reason, the two sheets of electronic paper 12 can be connected to each other.

As described above, the connectors 20 can be arranged facing each other to connect the two sheets of electronic paper 12 to each other. The connectors 20A are designed to be connected to each other to make it possible to connect three or more sheets of electronic paper 12 to each other. However, as an increase of the number of connectable sheets, it becomes more difficult to specify the connection positions of the sheets of electronic paper 12.

In order to solve the above problem, In the example in FIG. 6B, the electronic paper 12 can output a setting for indicating a connection position of the electronic paper 12. More specifically, in the example shown in FIG. 6B, in order to display the two sheets of electronic paper 12 in a page spread state, each of the sheets of electronic paper 12 has a recognition connection terminal unit 50A which can set four terminals, and comprises a setting unit 51 for setting a specific terminal selected from the terminals of the recognition connection terminal unit 50A.

The setting unit 51 sets any one of terminal as a receiving terminal 52, and sets one or more terminals among the four terminals, except the receiving terminal 52, as output terminals 54. In this manner, detection signals of one or more output terminals 54 of the four terminals except the receiving terminal 52 are detected, so that the position of the electronic paper 12 can be set.

When the connectors are designed to be connected to each other, a large number of sheets of electronic paper 12 can be connected in a page spread state. However, as the number of connectable sheets of electronic paper 12 increases, the number of signal lines for transmitting the detection signals increases.

Therefore, in the example shown in FIG. 6C, a writing device 14 having connectors 20C as a common bus is used. In order to return a recognition signal to the common bus, a setting value representing a connection position of the electronic paper 12 can be output from the electronic paper 12 depending on the connection position of the electronic paper 12. More specifically, in the example shown in FIG. 6c, an electronic paper 12B comprising a setting unit 51P for generating parallel data or serial data representing the position of the electronic paper 12 and using an input recognition signal as a power supply is used. The recognition connection terminal unit is constructed as a recognition connection terminal unit 50B. In the recognition connection terminal unit 50B, any one terminal functions as the receiving terminal 52, and all the other terminals function as the output terminals 54 serving as data terminals.

In this manner, the position data of the electronic paper 12 which is a setting value set by the setting unit 51P is transmitted through the common bus. With reference to this position data, the availability and the position of connection can be recognized.

As described above, in this embodiment, since the sheets of electronic paper 12 can be used in a page spread state, the number of sheets of electronic paper 12 can be increased or decreased depending on the size of an image to be displayed. Image information can be easily processed by the host computer 18 depending on a total size of the connected sheets of electronic paper 12.

[Third Embodiment]

In the first and second embodiments, the electric writing scheme has been explained as a scheme for writing image information on the sheets of electronic paper 12. However, in the third embodiment, the invention is applied to an optical information writing scheme.

Since this embodiment has the same configuration as that of the first or second embodiment, the same reference numerals as in the first or second embodiment denote the same parts in the third embodiment, and a description thereof will be omitted. A coordinate system, a connection relationship, and the like to be described later are only examples. The invention is not limited to these examples.

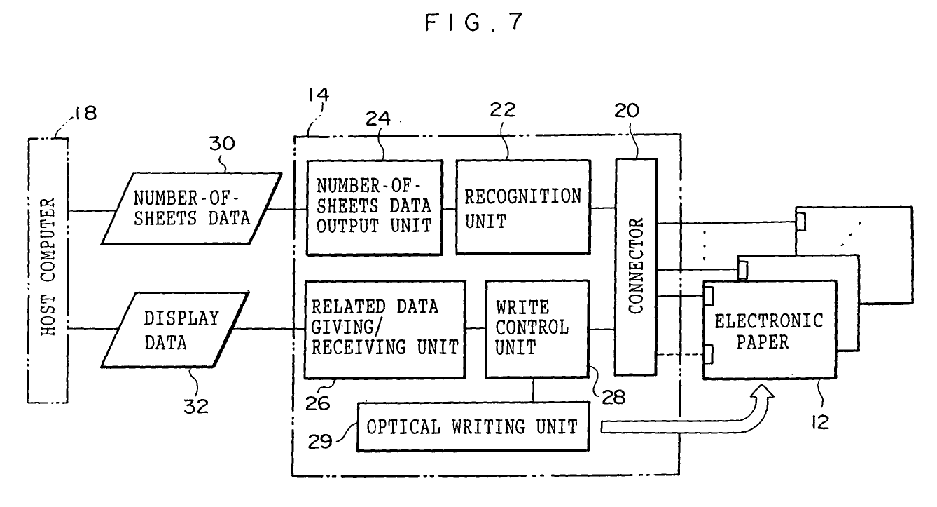

As shown in FIG. 7, a writing device 14 of an electronic book system 10 comprises an optical writing unit 29. This optical writing unit 29 is connected to a write control unit 28, and is installed in a position such that an optical beam depending on image information is irradiated on the electronic paper 12.

In this embodiment, the write control unit 28 is designed to output an image signal for forming an image of the image information to the optical writing unit 29 and to output a drive signal for driving the electronic paper 12 to the electronic paper 12 through a connector 20 in formation of an image by light irradiation.

As described above, in this embodiment, since a write operation is achieved by optical information, the number of connected sheets of electronic paper 12 can be easily recognized as an electronic book 16 regardless of types of display media serving as the sheets of electronic paper 12, and image information depending on the number of sheets can be written to display the image information.

[Fourth Embodiment]

Each of the above embodiments describes the case in which the number of sheets of electronic paper 12 connected to the writing device 14 is recognized by electric connection between the sheets of electronic paper 12 and the writing device 14 in a contact state. However, in this embodiment, the invention is applied to a case in which the number of connected sheets of electronic paper 12 is recognized in a non-contact state.

Since this embodiment has the same configuration as that of the above embodiment, the same reference numerals as in the first embodiment denote the same parts in the second embodiment, and a description thereof will be omitted.

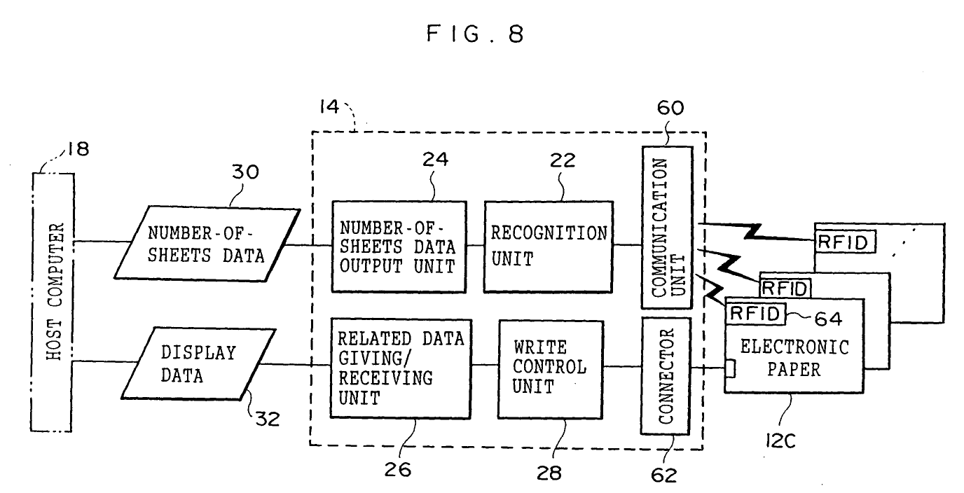

As shown in FIG. 8, the writing device 14 according to this embodiment comprises a communication unit 60 and a connector 62 in place of the connector 20. More specifically, the writing device 14 comprises the communication unit 60 as a configuration corresponding to the recognition terminal unit 40 and comprises the connector 62 as a configuration corresponding to the signal terminal 46.

A sheet of electronic paper 12C which can be used in an electronic book system 10 according to this embodiment comprises an RFID 64 for uniquely identifying the sheet of electronic paper 12C and for transmitting and receiving the identification information by air.

With the configuration, signal transmission/reception can be performed by radio communication between the communication unit 60 and the RFID 64.

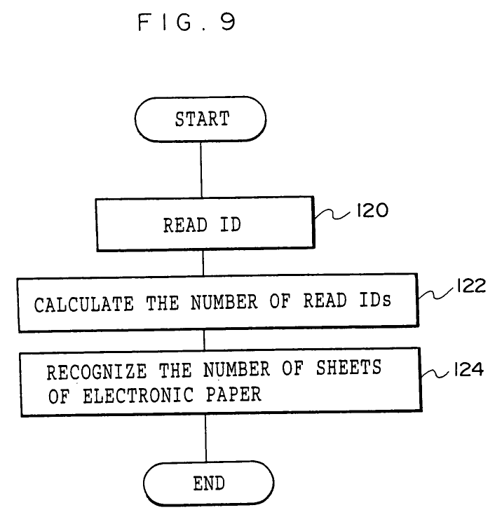

In this embodiment, in a recognition unit 22, the process routine in FIG. 9 is executed in place of the process routine in FIG. 4. In step 120, the unique information ID of the electronic paper 12C is read by signal transmission/reception with a radio signal between the communication unit 60 and the RFID 64 arranged on the electronic paper 12C. In the next step 122, the number of pieces of unique information ID of the sheets of electronic paper 12C read in step 120 is counted. In the next step 124, the number of sheets of electronic paper 12 connected to the writing device 14 is recognized on the basis of the counted value obtained in step 122.

As described above, in this embodiment, the number of sheets of electronic paper 12 connected to the writing device 14 constituted as the electronic book 16 can be recognized by using RFIDs. For this reason, the number of connected sheets of electronic paper can be recognized without arranging connectors on the writing device 14 side or arranging new connection terminals on the electronic paper 12 side.

[Fifth Embodiment]

FIG. 1 is a diagram showing the electronic book system 10 according to the fifth embodiment of the invention. In the electronic book system 10 according to the fifth embodiment, a case in which an image is displayed on only one surface of a paper-like display medium is exemplified. However, images may be displayed on the both surfaces as a matter of course.

The electronic book system 10 comprises a host computer 18 constituted by a personal computer in which a predetermined application program is installed and an electronic book 16 constructed like a book in appearance.

The electronic book 16 comprises a writing device 14 constructed like the scroop of a book and sheets of electronic paper 12 constructed like paper media. The writing device 14 holds the sheets of electronic paper 12 and performs control for writing images in the sheets of electronic paper 12.

In this case, the image is not limited by an image which simply appears by image data, and the image includes a character image which is represented by text data. In FIG. 1, although the four sheets of electronic paper 12 are illustrated, the number of sheets of electronic paper 12 is not limited to a specific number. In this embodiment, a sheet of electronic paper 12 serving as the uppermost upward sheet of electronic paper on the plane of FIG. 1 is defined as a top page, and the remaining sheets of electronic paper 12 are defined as the second page, the third page, . . . , in order downward from the plane of FIG. 1.

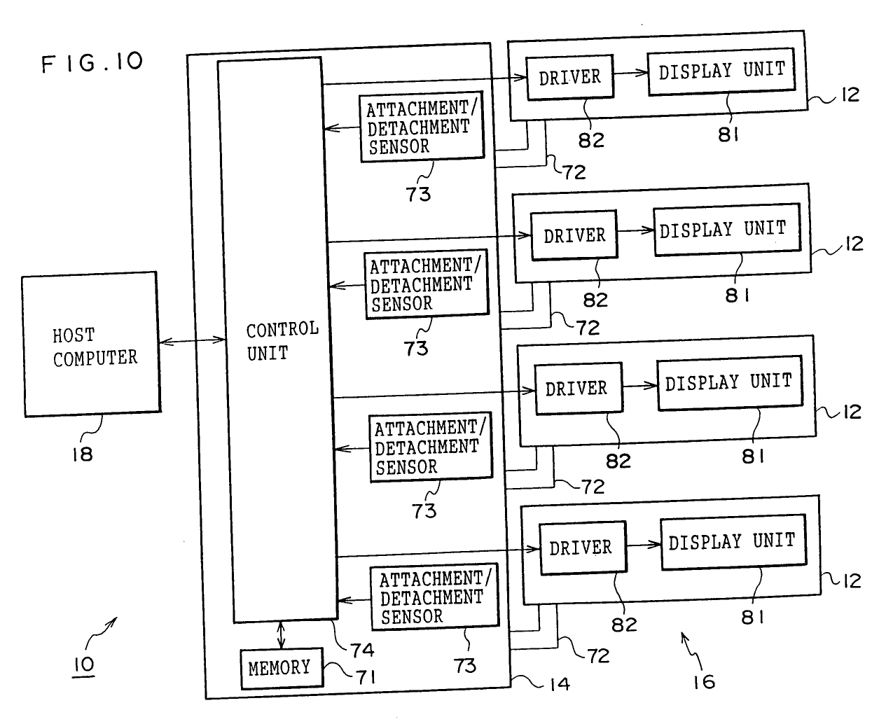

FIG. 10 is a block diagram showing a functional configuration of the electronic book system 10.

The writing device 14 comprises a memory 71 for storing an image transmitted from the host computer 18, a body connection unit 72 for connecting the electronic paper 12 to the writing device 14, a attachment/detachment sensor 73 for detecting a connection state between the writing device 14 (body connection unit 72) and the electronic paper 12, and a control unit 74 for performing control for writing an image in the electronic paper 12 according to an instruction from the host computer 18.

The body connection unit 72 electrically connects the writing device 14 and the sheets of electronic paper 12 to each other, and holds the sheets of electronic paper 12 such that the sheets of electronic paper 12 can be turned over. The body connection unit 72 holds the sheets of electronic paper 12 such that the sheet of electronic paper 12 is stacked on the display surface of the other sheets of electronic paper 12 and such that, when a given sheet of electronic paper 12 is turned over in some direction, the display surface of the sheet of electronic paper 12 adjacent to the given sheet of electronic paper 12 appears.

The attachment/detachment sensor 73 detects a connection state representing whether the writing device 14 (body connection unit 72) is connected to the electronic paper 12 or not, and supplies the detection result to the control unit 74. The attachment/detachment sensor 73 may detect a connection state representing whether the electronic paper 12 is electrically or mechanically connected to the writing device 14 or not. The method for detecting the connection state is not limited to a specific method.

The control unit 74 performs control for temporarily storing image data transmitted from the host computer 18 in the memory 71, reading the image data stored in the memory 71 according to an instruction from the host computer 18, and writing the image data in the sheets of electronic paper 12.

The electronic paper 12 comprises a display unit 81 for displaying an image and a driver 82 for driving the display unit 81 under the control of the control unit 74.

In the electronic book system 10 having the above configuration, first, the host computer 18 transmits the images of all the pages of a book to the electronic book 16. The writing device 14 of the electronic book 16 performs a process of writing the images of the pages transmitted from the host computer 18 in the sheets of electronic paper 12. A user can disconnect the host computer 18 from the electronic book 16, and carry only the electronic book 16 to read the electronic book 16.

In addition, the electronic book 16 executes a process of rewriting all or some of images displayed on a sheet of electronic paper 12 when the sheet of electronic paper 12 is removed or inserted.

(Removal of Electronic Paper 12)

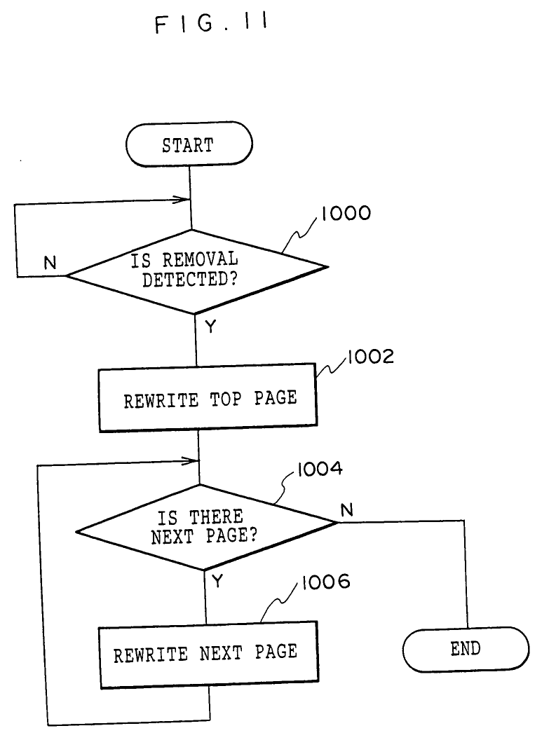

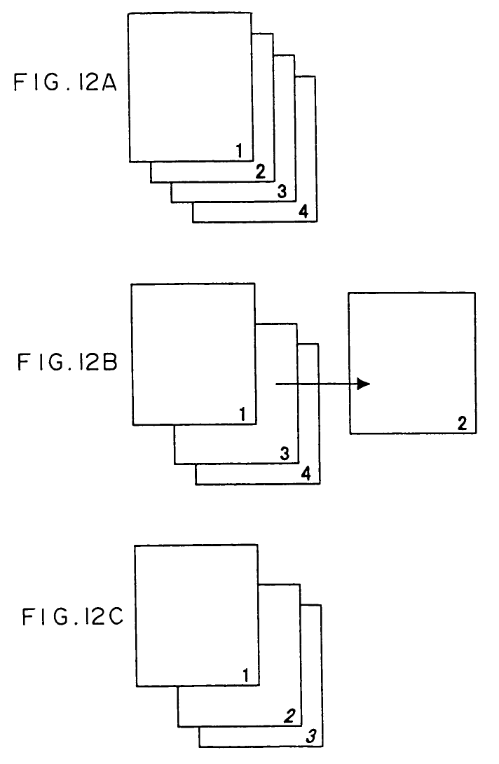

FIG. 11 is a flow chart showing an operation procedure of the control unit 74 of the writing device 14 when the electronic paper 12 is removed. FIGS. 12A to 12C are diagrams showing manners of removing the sheets of electronic paper 12 from the electronic book 16. As shown in FIG. 12A, a case in which four sheets of electronic paper 12 are used will be explained.

In step 1000, the control unit 74 detects whether any one of the sheets of electronic paper 12 is removed or not, on the basis of the detection result of the attachment/detachment sensor 73. When the control unit 74 detects that any one of the sheets of electronic paper 12 is removed, the process goes to step 1002. In this embodiment, as shown in FIG. 12B, it is assumed that the second sheet of electronic paper 12 is removed.

In step 1002, the control unit 74 reads an image from the memory 71 and rewrites the image of the sheet of electronic paper 12 serving as the top page. The process goes to step 1004.

In step 1004, the control unit 74 decides whether there is the next page or not, i.e., whether there is a sheet of electronic paper 12 which is not removed or not. When there is the next page, the process goes to step 1006. When there is no next page, rewriting of the pages is ended.

In step 1006, the control unit 74 rewrites the next page. The control unit 74 returns to step 1004. As a result, after the sheet of electronic paper 12 of the second page is removed, as shown in FIG. 12C, the images on the second and third pages are displayed on the sheets of electronic paper 12 of the third and fourth pages, respectively.

As described above, even if a sheet of the electronic paper 12 is removed, the control unit 74 repeats the processes in steps 1000 to 1006 so that images of sheets of electronic paper 12 which are not removed can be rewritten in the order of the current pages.

The example has been described, where the control unit 74 rewrites all the sheets of electronic paper 12. However, the position of a removed sheet of electronic paper 12 is detected, and only the pages subsequent to the page of the removed sheet of electronic paper 12 maybe rewritten. The case in which the sheet of electronic paper 12 of the second page is removed has been described above. However, even if the sheet of electronic paper 12 of an arbitrary page is removed, the control unit 74 can perform the same control as described above.

(Insertion of Electronic Paper 12)

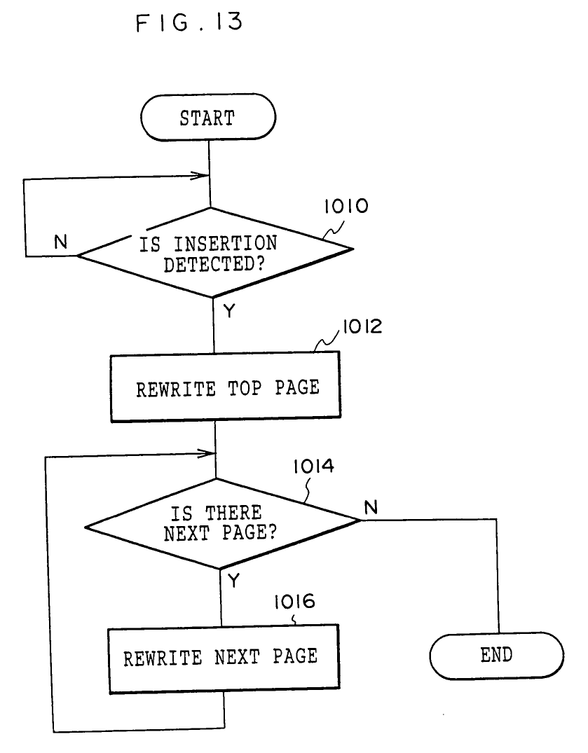

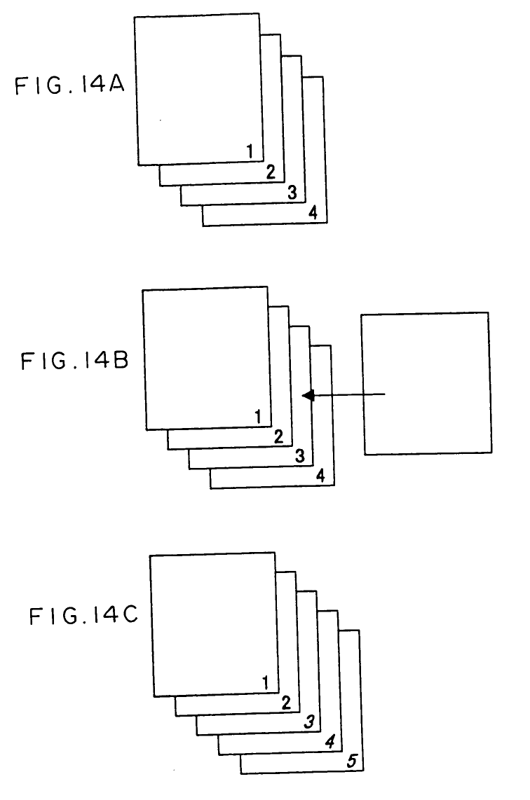

FIG. 13 is a flow chart showing an operation procedure of the control unit 74 of the writing device 14 when a new sheet of electronic paper 12 is inserted. FIGS. 14A to 14C are diagrams showing manners of inserting the sheets of electronic paper 12 into the electronic book 16. The following case will be explained. That is, as shown in FIG. 14A, four sheets of electronic paper 12 are used, and the fifth sheet of electronic paper 12 is inserted into an arbitrary position.

In step 1010, the control unit 74 detects whether a sheet of electronic paper 12 is inserted or not on the basis of the detection result of the attachment/detachment sensor 73. When the control unit 74 detects that the sheet of electronic paper 12 is inserted, the process goes to step 1012. In this embodiment, as shown in FIG. 14B, it is assumed that a new sheet of electronic paper 12 is inserted between the second and third pages.

In step 1012, the control unit 74 reads an image from the memory 71 and rewrites the image of the sheet of electronic paper 12 serving as the top page. The process goes to step 1014.

In step 1014, the control unit 74 decides whether there is the next page or not, i.e., whether there is a sheet of electronic paper 12 the image of which is to be rewritten or not. When there is the next page, the process goes to step 1016. When there is no next page, rewriting of the pages is ended.

In step 1016, the control unit 74 rewrites the next page, and the control unit 74 returns to step 1014. As a result, after the new sheet of electronic paper 12 is inserted, as shown in FIG. 14C, the images are displayed on the sheets of electronic paper 12 in the order of the pages, respectively.

As described above, even if a new sheet of the electronic paper 12 is inserted, the control unit 74 repeats the processes in steps 1010 to 1016 so that images can be rewritten in the order of the pages of the current sheets of electronic paper 12.

The example has been described where the control unit 74 rewrites all the sheets of electronic paper 12. However, the position of an inserted sheet of electronic paper 12 may be detected, and only the pages subsequent to the page including the inserted sheet of electronic paper 12 may be rewritten. Even if a sheet of electronic paper 12 is inserted into an arbitrary page, the control unit 74 can perform the same processes as described above.

(Replacement of Electronic Paper 12)

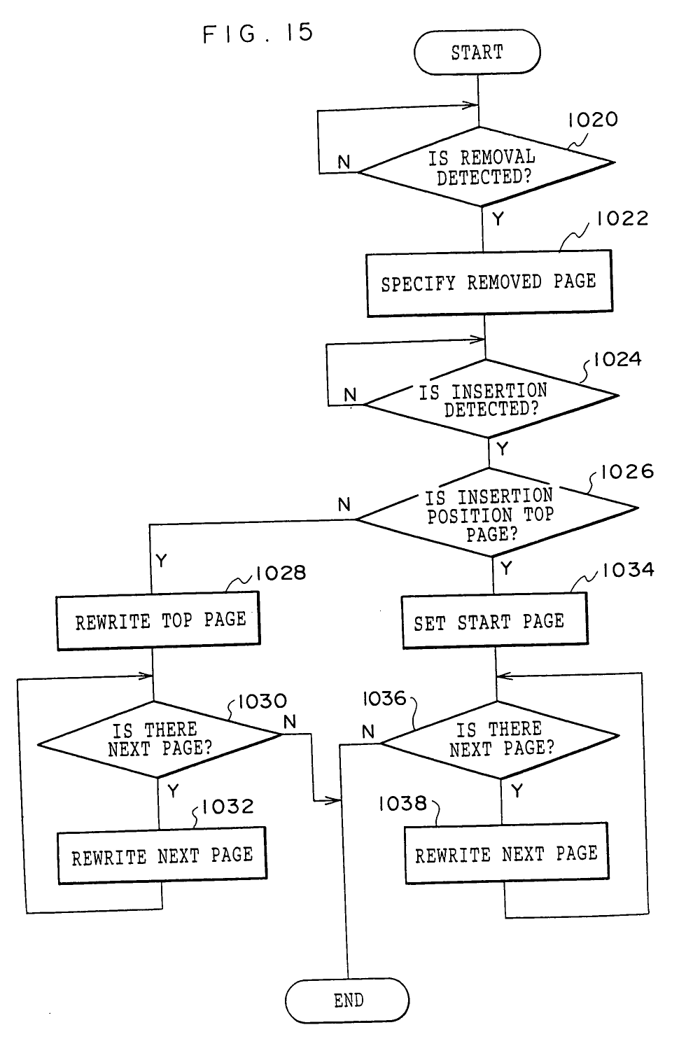

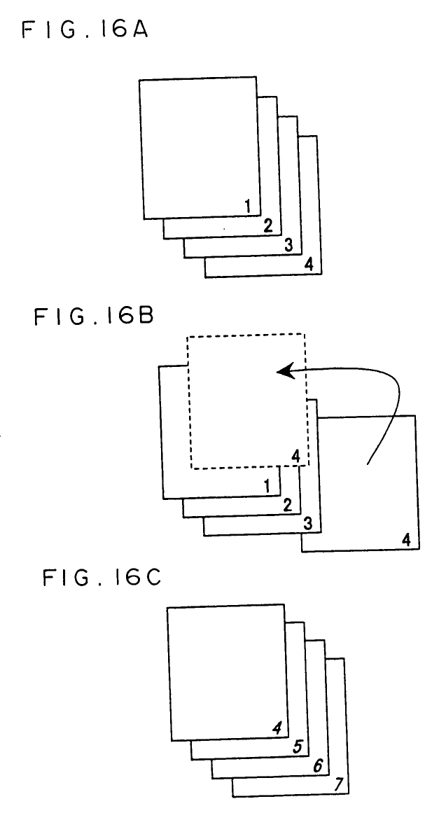

FIG. 15 is a flow chart showing an operation procedure of the control unit 74 of the writing device 14 when a sheet of electronic paper 12 is replaced with an arbitrary sheet of electronic paper 12. FIGS. 16A to 16C are diagrams showing manners of removing the sheets of electronic paper 12 from the electronic book 16 and inserting into other positions. As shown in FIG. 16A, a case in which four sheets of electronic paper 12 are used will be explained.

In step 1020, the control unit 74 detects whether any one of the sheets of electronic paper 12 is removed or not on the basis of the detection result of the attachment/detachment sensor 73. When the control unit 74 detects that any one of the sheets of electronic paper 12 is removed or not, the process goes to step 1022. In this embodiment, as shown in FIG. 16B, it is assumed that the final page (the sheet of electronic paper 12 of the fourth page) is removed.

In step 1022, control unit 74 specifies the page of the removed sheet of electronic paper 12. In this embodiment, the control unit 74 specifies the page of the removed sheet of electronic paper 12 as the fourth page to shift to step 1024.

In step 1024, the control unit 74 detects whether a sheet of electronic paper 12 is inserted or not on the basis of the detection result of the attachment/detachment sensor 73. When the control unit 74 detects that the sheet of electronic paper 12 is inserted, the process goes to step 1026.

In step 1026, the control unit 74 decides whether the position into which the sheet of electronic paper 12 is inserted in step 1024 is a top page or not. When the position is the top page, the process goes to step 1034. When the position is not the top page, the process goes to step 1028.

In step 1028, the control unit 74 reads an image from the memory 71 and rewrites the image on the electronic paper 12 serving as the top page to shift to step 1030.

In step 1030, the control unit 74 decides whether there is the next page or not, i.e., whether there is a sheet of electronic paper 12 the image of which is to be rewritten or not. When there is the next page, the process goes to step 1032. When there is no next page, rewriting of the pages is ended.

In step 1032, the control unit 74 rewrites the next page. The control unit 74 returns to step 1030.

Therefore, when the position into which the sheet of electronic paper 12 is inserted in step 1024 is not the top page in step 1024, only the order of the sheets of electronic paper 12 of the pages subsequent to the second page is changed. For this reason, the images of the sheets of electronic paper 12 are rewritten according to the order.

In step 1034, the control unit 74 sets a start page serving as a write start page to shift to step 1036. For example, when the image displayed on the sheet of electronic paper 12 is not erased by removal of the sheet of electronic paper 12, the image of the sheet of electronic paper 12 inserted into the top page need not be rewritten. In this case, the control unit 74 sets the second sheet of electronic paper 12 as a start page. On the other hand, when the image displayed on the sheet of electronic paper 12 is erased by removal of the sheet of electronic paper 12, the image must be written in the sheet of electronic paper 12 inserted into the top page again. In this case, the control unit 74 sets the sheet of electronic paper 12 of the top page (first page) as the start page.

In step 1036, the control unit 74 decides whether there is the next page. When there is the next page, the process goes to step 1038. When there is no next page, the control unit 74 ends rewriting of the pages.

In step 1038, the control unit 74 rewrites the next page to return to step 1036. As a result, when the sheet of electronic paper 12 of the fourth page is removed, and when the sheet of electronic paper 12 is inserted into the top page, as shown in FIG. 16C, the image of the fourth page is displayed on the top page, the images of the fifth to eighth pages are displayed on the second to fourth sheets of electronic paper 12, respectively.

As described above, when the final page (the sheet of electronic paper 12 of the fourth page) is removed and then inserted into the top page, the control unit 74 repeats the processes in steps 1020 to 1038, so that the subsequent images can be displayed on the second and subsequent sheets of electronic paper 12 in the order of the pages.

[Sixth Embodiment]

The sixth embodiment of the invention will be described below. The same reference numerals as in the fifth embodiment denote the same parts in the sixth embodiment, and a description thereof will be omitted.

The electronic book system 10 according to the sixth embodiment has the configuration shown in FIG. 10 as in the other embodiments.

A body connection unit 72 arranged in a writing device 14 of an electronic book 16 can not only hold two sheets of electronic paper 12 in a page spread state, but also hold three sheets of electronic paper 12 in a page spread state. The electronic paper 12 preferably has display surfaces on both the surfaces.

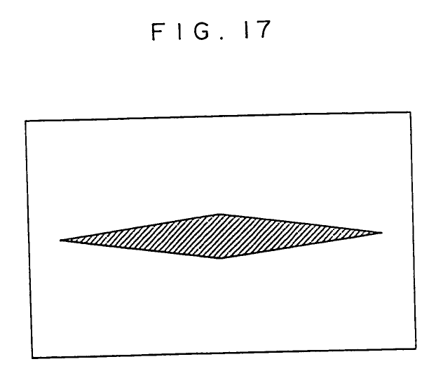

FIG. 17 is a diagram showing one image (to be referred to as a “reference image” hereinafter) showing a rhombus. In this embodiment, a case in which a new sheet of electronic paper 12 is inserted when the reference image is displayed on two sheets of electronic paper 12.

(Magnification Change)

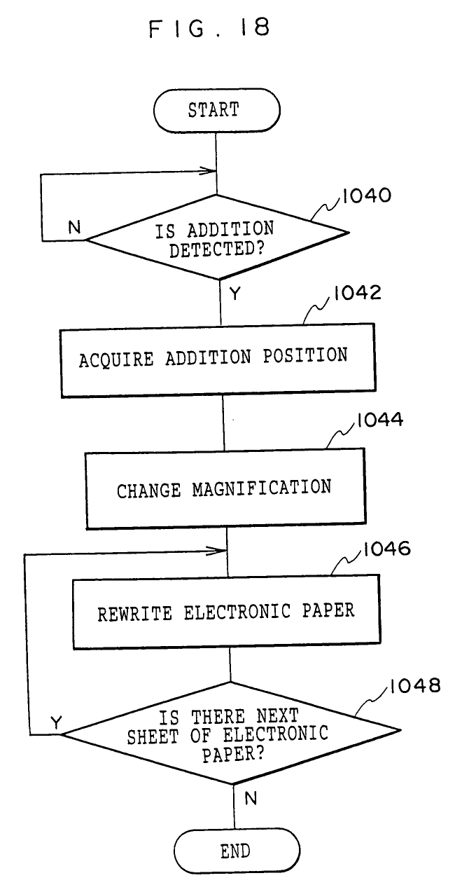

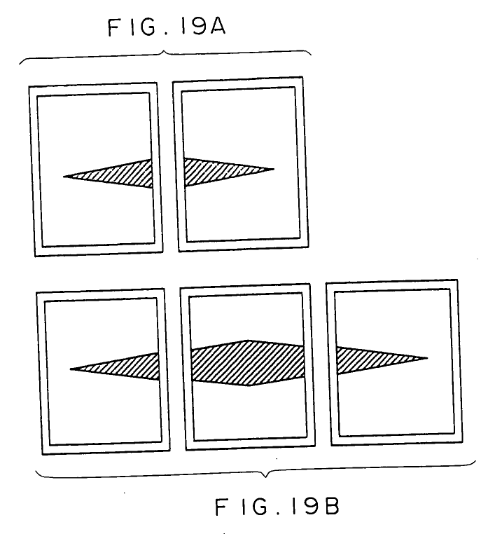

FIG. 18 is a flow chart showing an operation procedure of a control unit 74 when a magnification of a display image is changed simultaneously with addition of a sheet of electronic paper 12. FIG. 19A is a diagram showing a reference image displayed on two sheets of electronic paper 12, and FIG. 19B is a diagram showing a reference image displayed on three sheets of electronic paper 12. In this embodiment, as shown in FIG. 19A, it is assumed that the whole of the reference image is displayed on the two sheets of electronic paper 12.

In step 1040, the control unit 74 detects whether a sheet of electronic paper 12 is added or not on the basis of the detection result of the attachment/detachment sensor 73. When the control unit 74 detects that the sheet of electronic paper 12 is added, the process goes to step 1042.

In step 1042, the control unit 74 acquires the position of the added sheet of electronic paper 12 to shift to step 1044. In this embodiment, as shown in FIG. 19B, it is assumed that a new sheet of electronic paper 12 is added to a one-end side of the two sheets of electronic paper 12 in the direction of the continuous sheets of electronic paper 12.

In step 1044, the control unit 74 increases the magnification of a reference image within such a range that the whole of the rhombus of the reference image appears on the three continuous sheets of electronic paper 12 to shift to step 1046.

In step 1046, the control unit 74 rewrites one sheet of electronic paper 12 by using the magnified image data to shift to step 1048.

In step 1048, the control unit 74 decides whether there is the next sheet of electronic paper 12 or not, i.e., whether there is a sheet of electronic paper 12 which is not rewritten or not. When there is the next sheet of electronic paper 12 (sheet of electronic paper 12 which has not been rewritten), the control unit 74 returns to step 1046. When there is no next sheet of electronic paper 12, the control unit 74 ends the process. As a result, as shown in FIG. 19B, the reference image which is magnified is displayed on the three continuous sheets of electronic paper 12.

As described above, even if a sheet of electronic paper 12 is added to the continuous sheets of electronic paper 12, the control unit 74 repeats the processes in steps 1040 to 1048 to change the magnification of the image data such that the whole of the image appears on the newly continuous sheets of electronic paper 12. As a result, the image can be displayed on the sheets of electronic paper 12.

(Display Range Change)

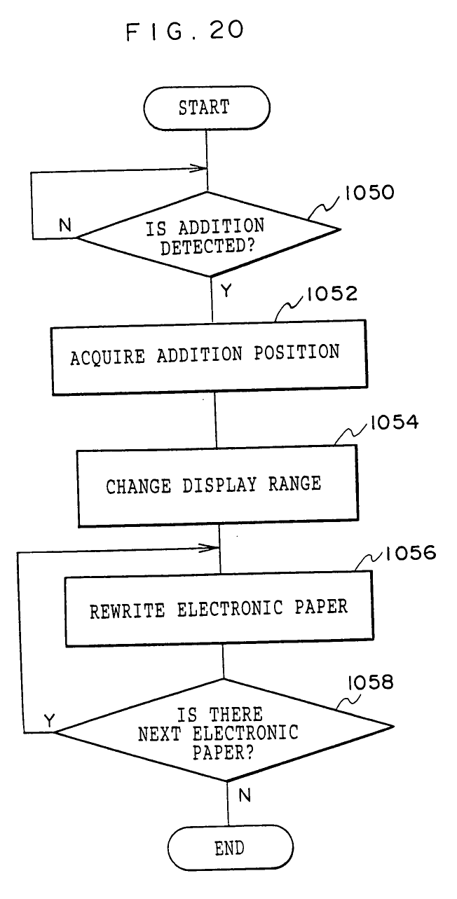

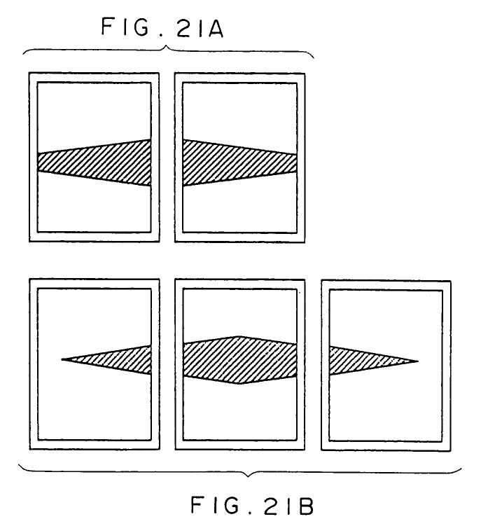

FIG. 20 is a flow chart showing an operation procedure of the control unit 74 when a display range of a display image is changed simultaneously with addition of a sheet of electronic paper 12. FIG. 21A is a diagram showing a reference image displayed on two sheets of electronic paper 12, and FIG. 21B is a diagram showing a reference image displayed on three sheets of electronic paper 12. In this embodiment, as shown in FIG. 21A, it is assumed that parts of (both the end portion of the rhombus in the longitudinal direction) of the reference image are imperfectly displayed on the two sheets of electronic paper 12.

In step 1050, the control unit 74 detects whether a sheet of electronic paper 12 is added or not on the basis of the detection result of the attachment/detachment sensor 73. When the control unit 74 detects that the sheet of electronic paper 12 is added, the process goes to step 1052.

In step 1052, the control unit 74 acquires the position of the added sheet of electronic paper 12 to shift to step 1054. In this embodiment, as shown in FIG. 21B, it is assumed that a new sheet of electronic paper 12 is added to a one-end side of the two sheets of electronic paper 12 in the direction of the continuous sheets of electronic paper 12.

In step 1054, the control unit 74 changes the display range of the rhombus for the three continuous sheets of electronic paper 12 to shift to step 1056. In this embodiment, the display range is changed by horizontally sliding the reference image without changing the magnification of the image data such that the whole of the rhombus is displayed on the three continuous sheets of electronic paper 12.

In step 1056, the control unit 74 rewrites one sheet of electronic paper 12 by using the image data the display range of which is changed to shift to step 1058. In steps 1056 and 1058, the control unit 74 executes the same processes as those in steps 1046 and 1048. As a result, as shown in FIG. 21B, a reference image the display range of which is changed is displayed on the three sheets of electronic paper 12.

As described above, even if a new sheet of electronic paper 12 is added to the continuous sheets of electronic paper 12, the control unit 74 repeats the processes in steps 1050 to 1058 to change the display range of the image data such that the whole of the image appears on the newly continuous sheets of electronic paper 12. As a result, the image can be displayed on the sheets of electronic paper 12.

This embodiment exemplifies the case in which a new sheet of electronic paper 12 is added to a one-end side of the two sheets of electronic paper 12 in the direction of the continuous sheets of electronic paper 12. However, even if a new sheet of electronic paper 12 is added between the two sheets of electronic paper 12, the control unit 74 can perform control for rewriting the sheets of electronic paper 12. This embodiment also exemplifies the case in which a sheet of electronic paper 12 is added. However, even if the sheet of electronic paper 12 is removed, the control unit 74 can change the magnification or display range of an image.

The invention is not limited to the first to sixth embodiments. The invention can also be applied to modifications which are changed without departing from the spirit and scope of the invention, as a matter of course.

For example, communication between the host computer 18 and the electronic book 16 may be performed by wire or by wireless.

As has been described above, according to the invention, since the number of sheets of display media connected by a connection unit is recognized by a recognition unit, the number of connected display media and the number of displayable pages can be easily recognized advantageously. Furthermore, when a change of a connection state between at least one of the display media and the connection units is detected, rewriting of at least a part of an image displayed on the display media connected to the connection unit is changed depending on the detected connection state. For this reason, even if an arbitrary display medium is attached or detached, an optimum image can be displayed on the loaded display media.

What is claimed is:

1. A display control device comprising:
a connection unit for connecting a plurality of display media in which image information to be displayed can be written by an external input;
a recognition unit for recognizing the number of display media connected to the connection unit; and
a writing unit for writing related information for writing the image information in the display media.

2. A display control device according to claim 1, wherein the display medium is detachably connected to the connection unit.

3. A display control device according to claim 1, further comprising a detection unit for detecting that the display medium is connected to the connection unit.

4. A display control device according to claim 3, wherein the recognition unit recognizes the number of display media by counting the number of display media detected by the detection unit.

5. A display control device according to claim 1, wherein the connection unit is connected to each display medium by being brought into contact with the display medium.

6. A display control device according to claim 5, wherein the display media have connector elements, and the connection unit has a plurality of connection sections to be connected to the connector elements of the display media.

7. A display control device according to claim 5, wherein each display medium has a connection element to which an input terminal and an output terminal are connected,
the connection unit comprises a terminal pair for each connectable display medium, said terminal pair comprising a recognition signal supply terminal for outputting a recognition signal to the input terminal of the connection element and a recognition signal detection terminal for detecting a recognition signal from the output terminal of the connection element, and
the recognition unit counts recognition signals at the recognition signal detection terminals of the connection unit.

8. A display control device according to claim 6, wherein the display medium has a connection element to which an input terminal and an output terminal are connected,
the connection unit comprises a terminal pair for each connectable display medium, said terminal pair comprising a recognition signal supply terminal for outputting a recognition signal to the input terminal of the connection element and a recognition signal detection terminal for detecting a recognition signal from the output terminal of the connection element, and
the recognition unit counts recognition signals at the recognition signal detection terminals of the connection unit.

9. A display control device according to claim 1, wherein the connection unit is connected to display media by radio communication without being in contact with the display media.

10. A display control device according to claim 8, wherein the display media have RFIDs representing pieces of unique information which can be given and received by radio communication, and the recognition unit counts the RFIDs.

11. A display control device according to claim 1, wherein the display media are memory-type display media.

12. A display control device according to claim 1, further comprising a transmission unit for transmitting number information representing the number of display media recognized by the recognition unit.

13. A display control device according to claim 12, wherein the transmission unit transmits the number information to an external computer through a communication line.

14. A display control device according to claim 1, further comprising a receiving unit for receiving image information related to an image to be displayed on the display medium from an external computer, wherein, on the basis of the image information received by the receiving unit and the number of display media recognized by the recognition unit, the writing unit writes related information in the display media.

15. A display control device according to claim 1, wherein the writing unit writes image information to be displayed on the display media as the related information.

16. A computer comprising:
a storage unit for storing related information related to an image to be displayed on a display medium;
a receiving unit for receiving the number of the display media; and
a transmission unit for transmitting the image information on the basis of the number of the display media received by the receiving unit and the image information stored in the storage unit.

17. A display control device comprising:
a connection unit for detachably connecting to each of a plurality of display media;
a detection unit for detecting connection states between the display media and the connection unit; and
a rewrite control unit for, when a change of a connection state between at least one of the display media and the connection unit is detected by the detection unit, controlling rewriting of at least a part of an image displayed on the display medium connected to the connection unit depending on the detected connection state.

18. A display control device according to claim 17, wherein the rewrite control unit rewrites the image displayed on at least one of the display media into a different image when the change of the connection state is detected by the detection unit.

19. A display control device according to claim 17, wherein, when the detection unit detects that a new display medium has been connected to the connection unit, the rewrite control unit rewrites in the new display medium at least one part of an image displayed on at least one of the display media.

20. A display control device according to claim 17, wherein the connection unit connects to the display media such that one display medium is stacked so as to cover a display surface of one adjacent display medium, and, when the one display media is turned over in some direction, the display surface of the one adjacent display medium appears.

21. A display control device according to claim 20, wherein, when the detection unit detects connection between a new display medium and the connection unit, the rewrite control unit writes an image in the new display medium and a display medium having a display surface facing the new display medium.

22. A display control device according to claim 17, wherein the connection unit connects at least two display media in a page spread state.

23. A display control device according to claim 22, wherein the rewrite control unit rewrites an image by changing a magnification of at least a part of the image on the display media connected to the connection unit after the change of the connection state is detected by the detection unit.

24. A display control device according to claim 23, wherein the rewrite control unit rewrites an image by changing a magnification of the image depending on a displayable region of the display media connected to the connection unit.

25. A display control device according to claim 22, wherein the rewrite control unit rewrites an image by changing a display position of the image on the display media connected to the connection unit after the change of the connection state is detected by the detection unit.

26. A display control device according to claim 25, wherein the rewrite control unit rewrites an image by changing a display position of the image depending on a displayable region of the display media connected to the connection unit.

27. A display control device according to claim 17, wherein the rewrite control unit rewrites images of the display media such that the contents of the images are continuous in a display order of the display media connected to the connection unit.

28. A display control device according to claim 17, wherein a connection state detected by the detection unit includes the number of display media connected to the connection unit.

29. An image display device comprising:
a plurality of display media; and
a display control device including a connection unit for detachably connecting to each of the plurality of display media, a detection unit for detecting connection states between the display media and the connection unit, and a rewrite control unit for, when a change of a connection state between at least one of the display media and the connection unit is detected by the detection unit, controlling rewriting of at least a part of an image displayed on the display medium connected to the connection unit depending on the detected connection state.

30. An image display system comprising:
an image display device including a plurality of display media, a connection unit for detachably connecting to each of the plurality of display media, a detection unit for detecting connection states between the display media and the connection unit, and a rewrite control unit for, when a change of a connection state between at least one of the display media and the connection unit is detected by the detection unit, controlling rewriting of at least a part of an image displayed on the display medium connected to the connection unit depending on the detected connection state; and
a main control device for transmitting an image to a display control device of the image display device and instructing the display control device to write the image.
